(19) United States
(12) Patent Application Publication
(10) Pub. No.: US 2014/0193303 A1
(43) Pub. Date: Jul. 10, 2014

(54) Apparatus for Extracting Oil From Oil-Bearing Plant Material

(71) Applicants: Matthew A. Ellis, Englewood, CO (US); Marcus J. Fauth, Denver, CO (US)

(72) Inventors: Matthew A. Ellis, Englewood, CO (US); Marcus J. Fauth, Denver, CO (US)

(21) Appl. No.: 13/734,915

(22) Filed: Jan. 4, 2013

(51) Int. Cl. B01D 11/02

(52) U.S. Cl. CPC B01D 11/0288
USPC 422/119; 422/274; 422/281

(57) ABSTRACT

A system for extracting oil from oil-bearing plant parts has an extraction vessel supported by an upright stand and a separator vessel mounted below the extraction vessel. A source of hydrocarbon solvent supplies liquid gas to the top of the extraction vessel, while a recycling pump connected to the separator vessel facilitates transport of the solvent through the plant material in the extraction vessel. The solvent is recovered and re-circulated, while extracted oil is removed from the separator. A thermal jacket is mounted on the separator; the thermal jacket supplies heat and cold to the interior of the separator and helps evaporate and condense the solvent.

### BACKGROUND OF THE INVENTION

This invention relates to an apparatus and method of extracting oil from oil-bearing plant parts, and more particularly, to an apparatus and method of extracting plant oil using a hydrocarbon solvent agent.

Plant oils have been extracted from plant material for centuries. Many plant oils are extracted from seeds by squeezing or crushing the seeds to force out the oil therefrom. Mechanical oil extractors or expellers are extensively used for obtaining cold-pressed oils where the temperature of starting material does not exceed 120° F. In order to increase the oil output, the oil extraction methods provide for the addition of heat and pressure.

In addition, plant oils can be extracted with the assistance of a chemical agent or solvent, such as hexane. Chemical extraction is cheaper and more efficient than mechanical extraction, at a large scale, leaving only 0.5-0.7% of the oil in the plant solids, as compared to 6-14% for mechanical extraction.

Plant seeds and pods are not the only plant components that contain oil. Fibrous plant matter, including leaves, flowers, etc. contain significant amounts of plant oil that can be extracted and used in cosmetics, healthcare industries and the like. Many solutions have been developed to provide plant oil extraction. For instance, U.S. Pat. No. 5,516,923 discloses a method of plant oil extraction, according to which grounded plant material is deposited into a reactor vessel, and vacuum is created in the reactor vessel. Liquid solvent is introduced into the reactor vessel and allowed to contact the plant material for a time sufficient to dissolve oil from the plant material, while the temperature in the reactor vessel is maintained at a level which prevents denaturing of constituent components of the plant oil and the plant material. Additional solvent vapors are introduced into the bottom of the reactor to cause mixing of the plant material and the solvent and separate fine particulate matter from heavier particles. Pressurized heated solvent vapors are introduced into the top of the reactor vessel while the liquid solvent and oil combination is being removed from the bottom of the reactor vessel through filters. To prevent clogging of filters in the bottom of the reactor vessel pressurized solvent vapors are forced through the filters into the bottom of the reactor vessel. The solvent and oil combination is transferred into a separator vessel, wherein the solvent is vaporized and removed for recycling, while the oil is removed into a holding tank.

U.S. Pat. No. 7,002,029 discloses a process for solvent extraction of oils, in an extraction chamber. According to this method, solvent mist with significant adiabatic cooling is introduced into the extraction chamber, whereby a pressure difference between the solvent inlet and outlet of the extraction chamber drives the solvent mist through the raw oil material. The solvent is fed to the extraction chamber at pressures exceeding atmospheric pressure, and the outlet of the extraction chamber is subject to a partial vacuum.

U.S. application Publication No. 2009/0028971 discloses a method utilizing compressed hydrocarbons. Residues from the crop and fruit treatment, especially from the treatment of pips and berries, are used as starting materials. The method is carried our without organic solvents, while applying low pressures and reduced extraction agent throughputs. Preferred extraction agents are ethane, propane, butane and the mixtures thereof, the extraction itself being carried out in batches at pressures of <50 mPa and temperatures of about 70° C., with an extraction agent throughput of between 4 and 20 kg/kg of starting materials.

U.S. application Publication No. 2011/0133120 teaches a method of plant oil extraction, which provides for a hermetically first tank coupled to a first valve, the first tank for storing a solvent comprising Butane, an extraction zone comprising an extraction chamber coupled between the first valve and a second valve, the extraction chamber having a filter proximate to the second valve; the extraction chamber has a volume between ¼ and ⅙ of the volume of the first tank. A filter separates flowing butane solvent and plant oil from organic plant material in the extraction chamber. A second tank has an exit valve for removing plant oil located on a bottom portion of the second tank, and an exit valve located near a top portion of the second tank.

U.S. application publication No. 2011/0100894 teaches a plant oil extraction device that has a main body member with a hollow interior that receives a plant. A filter member is removably mounted on the main body and has a groove therein that receives glass frit. Thus, when a solvent is placed in the hollow interior with the plant the glass frit filters the plant particulate allowing plant oil and solvent to flow into a receiving vessel. Once the oil is collected the filter member may be removed from the main body such that the glass frit can be cleaned of all plant particulate and be reused.

While the methods discussed above may work satisfactory in different environments, there is a need for an easy-to-operate inexpensive apparatus and method of plant oil extraction that can be used in a non-industrial setting by a cosmetics laboratory, small shop and by a consumer.

### SUMMARY OF THE INVENTION

It is, therefore, an object of the present invention to provide an apparatus and method of plant oil extraction that is suitable for extracting oil from raw plant material with the assistance of a liquid solvent.

It is another object of the present invention to provide an apparatus and method of plant oil extraction that is suitable for extracting oil from raw plant material in a simple and inexpensive manner.

These and other objects of the invention are achieved through a provision of a system for extracting oil from oil-bearing plant parts has an extraction vessel supported by an upright stand and a separator vessel mounted below the extraction vessel. A source of hydrocarbon solvent supplies liquid gas to the top of the extraction vessel, while a recycling pump connected to the separator vessel facilitates transport of the solvent through the plant material in the extraction vessel. The solvent is recovered and re-circulated, while extracted oil is removed from the separator. A thermal jacket is mounted on the separator; the thermal jacket supplies heat and cold to the interior of the separator and helps evaporate and condense the solvent. The system has a compact design suitable for a small lab or workshop.

### BRIEF DESCRIPTION OF THE DRAWINGS

Reference will now be made to the drawings, wherein like parts are designated by like numerals, and wherein

FIG. 1 is a schematic view of the system according to the present invention.

FIG. 2 is an exploded view of the extractor vessel according to the present invention.

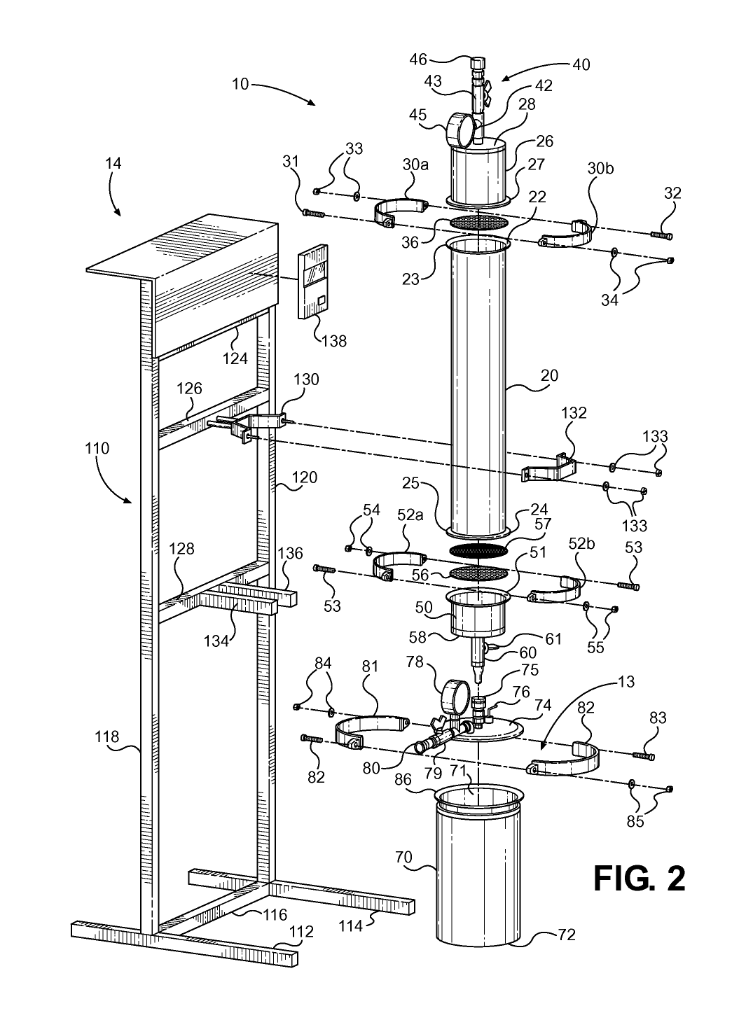

### DETAIL DESCRIPTION OF THE INVENTION

Turning now to the drawings in more detail, numeral 10 designates the system of plant oil extraction according to this invention. The system 10 comprises an extraction assembly 12, a separator assembly 13, an upright support assembly 14, which supports the extraction assembly 12, and a solvent recovery assembly 16. If desired, the support assembly 14 can also support the separator assembly 13.

The extraction assembly 12 comprises a tubular hollow extraction vessel 20 having an open top 22 and an open bottom 24. A peripheral flange 23 extends outwardly from the open top 22. A similar peripheral flange 25 extends outwardly from the open bottom 24.

A top cup 26 normally detachably engages with the open top 22. The top cup has an open bottom that matches the size and configuration of the top open end 22 of the extraction vessel 20. The top cup 26 is provided with a peripheral flange 27 that matches the top peripheral flange 23 of the extraction vessel 20. A two-piece top clamp member 30 having clamp members 30a and 30b secures the peripheral flanges 23 and 27 with the help of bolts 31, 32 and nut/washer assemblies 33, 34.

A perforated gasket 36 is sandwiched between the bottom of the top cup 26 and the top open end 22 of the extraction vessel 20. The perforated gasket 36 allows the gas to atomize before saturating the biomass material in the extraction vessel 20. The gasket 36 also prevents the biomass from moving upwardly into the top cup 26.

The top cup 26 has a closed top plate 28, which carries a connector assembly 40. The connector assembly 40 comprises operationally connected, an extractor connector conduit 42, a gas inlet valve 43 fitted in the extractor connector conduit 42, and a pressure gauge 45 connected to the gas inlet valve 43. The top of the extractor connector conduit 42 is provided with a quick connect male connector member 46.

A bottom cap 50 is detachably secured to the bottom end 24 of the extraction vessel 20. The bottom cup 50 is provided with a matching peripheral flange 51 extending about an open upper edge of the bottom cup 50 and securable to the bottom peripheral flange 25 of the extraction vessel 20. A two-piece clamp assembly 52 having clamp members 52a and 52b secures the flanges 25 and 51 with the bolts 53 and nut/washer assemblies 54, 55. In one aspect of the invention, the top cup 26 has longitudinal dimensions at least slightly greater, and preferably twice the longitudinal dimensions of the bottom cup 50, allowing for more head space for the gas of the solvent moving into the extraction vessel 20.

A bottom perforated gasket 56 and a micron screen 57 are sandwiched between the bottom cup 50 and the bottom end 24 to fine filter the extracted oil. The perforated gaskets 36 and 56 can be made of non-reactive metal, such as for instance stainless steel.

The bottom cup 50 is provided with a bottom plate 58. A liquid outlet conduit 60 of the extraction vessel 20 is fitted in the bottom plate 58. An extractor outlet valve 61, which can be a ball valve, is operationally connected with the liquid outlet conduit 60. A quick connect connector member 62 is secured to the lower end of the liquid outlet conduit 60.

The separator assembly 13 is mounted below the extraction assembly 20 in fluid communication therewith. The separator assembly 13 comprises a hollow separator vessel 70, which has an open top 71 and a closed bottom 72. A separator vessel cap 74 is detachably engageable with the open top 71 of the separator vessel 70. The separator vessel cap 74 sealingly closes the open top 71. The separator vessel cap 74 carries a separator connector conduit 75, which is configured for sealing engagement with the connector member 62 of the bottom cup 50.

A thermal probe member 76 is mounted on the separator vessel cap 74. A gas outlet conduit 77 is mounted on the separator vessel cap 74 in fluid communication with the separator vessel 70. The gas outlet conduit 77 is provided with a pressure gauge 78, a gas outlet valve 79 and a quick disconnect member 80. The gas outlet conduit 77 is operationally connected to the gas recovery assembly 16 via a gas return line 100.

The separator vessel cap 74 is secured to the separator vessel 70 using a two-piece clamp assembly comprised of clamp members 81 and 82. Bolts 82, 83 and nut/washer assemblies 84, 85 secure the clamp members 81 and 82 in tight engagement about the periphery of the separator vessel cap 74 and the separator vessel 70. A gasket 86 is fitted between the separator vessel cap 74 and the open top of the separator vessel 70 to ensure a fluid-tight seal therebetween.

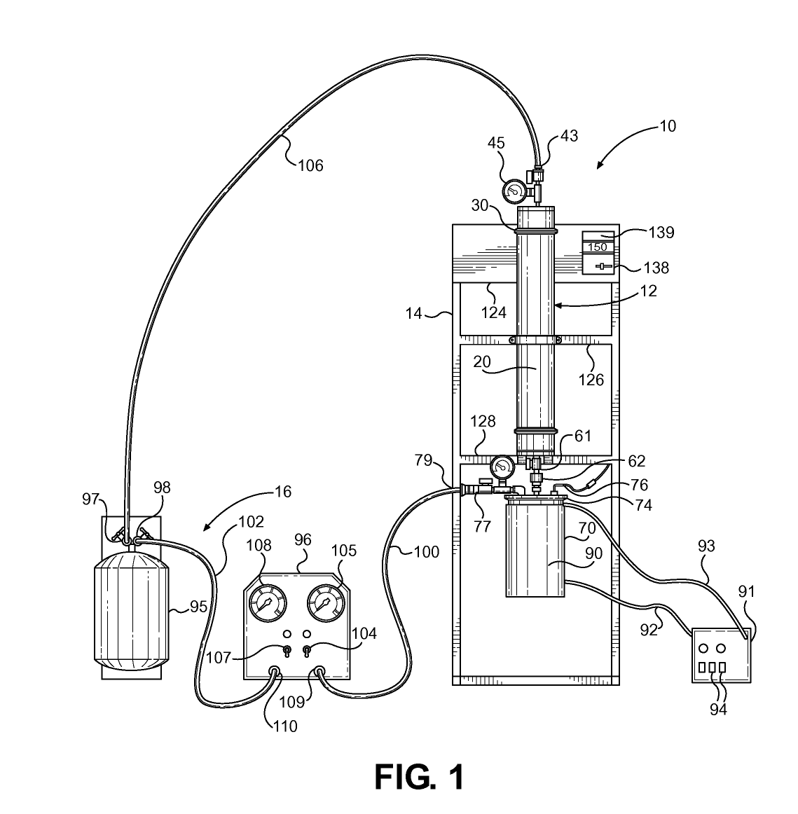

The separator assembly 13 also comprises a thermal jacket 90, which is secured on the exterior of the separator vessel 70. A heat source 91 supplies heat to the thermal jacket 90 such that the contents of the separator vessel 70 can be heated to a pre-determined temperature. In one aspect of the invention, the heat source 91 is a re-circulating water heater connected by a water line in 92 and a water line out 93 to the thermal jacket 90. The re-circulating water heater 91 is provided with the control buttons and gauges 94, schematically illustrated in FIG. 1, for controlling the desired temperature in the thermal jacket 90. Of course, other heat sources can be used for heating the separator vessel 70.

The solvent recovery assembly 16 is mounted between the source of solvent (gas tank 95) and the separator assembly 13. The solvent recovery assembly comprises a gas recovery/control unit 96 and associated connection hoses, or lines. On the inlet side, the gas recovery/control unit 96 is connected to the gas return line 100; on the outlet side—to the gas tank 95 via a gas conduit 102. The gas recovery/control unit 96 has a recycling pump controlled by a control knob 104 and having a pressure indicator 105. A condenser is provided in the gas recovery/control unit for condensing gas evacuated from the separator vessel 70. The condenser has a control knob 107 and a monitor 108 on the face of the gas recovery/control unit 96.

The gas tank 95 contains a hydrocarbon solvent, such propane or butane. The gas tank 95 is operationally connected, on the outlet side, to the gas inlet valve 43 of the extraction assembly 12 via a liquid gas line 106. Liquid gas (which can be propane) exits the gas tank 95 via a liquid port 97 to act as a solvent for the oil extraction process enters through a gas port 98 via the gas conduit 102 as recovered condensed gas. The gas recovery/control unit 105 has an inlet port 109 and an outlet port 111.

The support assembly 14 comprises an upright stand 110 having a frame-like structure. A pair of base members 112 and 114 is secured in a spaced-apart parallel relationship by a cross bar 116. The base members 112, 114 are designed to rest on a horizontal surface in a work shop, lab, etc. Upright supports 118 and 120 extend upwardly from the base members 112, 114, respectively, at right angles to the axes of the horizontal base members 112, 114.

Spaced apart parallel cross members 124, 126 and 128 extend between the upright members 118 and 120 further ensuring stability of the support assembly 14. The cross member 126 carries a Y-shaped upper yoke 130, which extends horizontally from the cross member 126 transversely to a longitudinal axis of the cross member 126. A securing member 132 is provided for engagement with the upper yoke 130 such that the yoke 130 and the securing member 132 encircle the extraction vessel 20 suspending it on the stand 110. Wing nut/washer assemblies 133 engage the outwardly extending flanges of the yoke 130 and the securing member 132 to fix position of the yoke about the extraction vessel 20.

A pair of bottom support bars 134, 136 are secured in a spaced-apart relationship from the cross member 128. The bottom support bars 134, 136 extend transversely to a longitudinal axis of the cross member 128. The bottom plate 58 of the bottom cup 50 rests on the bottom support bars 134, 136 when the extraction assembly is mounted on the stand 110.

The support assembly 14 also supports a temperature monitor unit 138 for the thermal probe 76 of the separator vessel 20. The temperature monitor unit 138 forms a part of the separator assembly 13. The temperature monitor unit 138 is provided with a temperature indicator 139, which allows visual determination of the thermal conditions inside the separator vessel 70.

In operation, the user removes the high pressure clamp 30 connecting the top cup 26 to the extraction vessel 20. The user then loads the organic plant material into the extraction vessel 20 and reattaches the top cup 26 to the extractor vessel 20 with the high pressure clamp 30. The user then opens the gas inlet valve 43 and extractor outlet valve 61. The user also attaches the vacuum hose 106 to the gas inlet valve 43.

Next, the user turns on the recycling pump using the control knob 104 and allows the gas recovery/control unit it to pull a vacuum on the extractor vessel 20 and the separator vessel 70. Once vacuum has been reached, as evident from monitoring the pressure indicator 105, the valves 43 and 61 are closed. The hose 106 can now be disconnected from the recycling pump and connected to the liquid port 97 on the gas tank 95.

The liquid port 97 is opened, and the gas inlet valve 43 is also slowly opened. This will allow the solvent (propane) from the gas tank 95 to enter the extraction vessel 20. The flow of solvent continues until between four to five pounds of solvent are delivered into the extraction vessel 20. Then the gas inlet valve 43 and the liquid port 97 on the gas tank 95 are closed.

Continuing with the extraction process, the user opens the extractor outlet valve 61 allowing the solvent and the extract to move from the extraction vessel 20 to the separator vessel 70. During this step, the user connects the hose 100 house to the inlet port 109 on the gas recovery/control unit 95 and the other end of the hose 100—to the gas outlet valve 79 of the separator assembly 13. The extraction process is usually complete when the contents of extraction vessel 20, being under vacuum, reach above 60° F.

Next, the user connects one side of the hose 102 to the discharge port 110 of the gas recovery/control unit 96 and the other side—to the gas port 98 on the gas tank 95. The gas recovery pump is turned using the control knob 107, while the gas outlet valve 79 of the separator vessel is opened. During this time, the re-circulating water heater 91 is circulating hot water through the thermal jacket 90. The heat is transferred to the separator vessel 70 allowing the solvent to be separated from the extracted oil and converted back into a gas.

The gas recovery/control unit 96 recovers that gas and pumps it back in to the gas tank or recovery cylinder 95. The thermal probe 76 in the separator vessel 70 is attached to the thermostat 138 allowing the user to monitor the temperature in the separator vessel 70 during this process. Once all of the gas has been removed from the separator vessel 70, the user closes the extractor outlet valve 61 and the gas outlet valve 79, and disconnects the line 100 from the gas outlet valve 79.

The separator vessel 70 is disconnected from the from the extractor assembly 12 using the quick disconnect connector below the extractor vessel 20. Once the separator vessel 70 is detached from the extractor vessel 20, the user can remove the high pressure clamp that is connecting the separator cap 74 to the separator vessel. The extracted oil can now be removed from the separator vessel. The process can then be repeated by loading a new batch of plant material into the extraction vessel 20, forcing the solvent through the plant material and separating the extracted oil from the plant material.

In one aspect of the invention, both the separator vessel 70 and the extraction vessel hold equal amounts of volume. The volume may be between 5 to 1-liters. The separator vessel 70 has a fixed thermal water jacket 90 that allows hot or cold water to be circulated around the separator, when required. In an alternative embodiment, the water heater is replaced with an electric heater. If desired a filtration vessel may be incorporated between the extraction vessel and the separator vessel to filter biomass from the liquid solvent and extracted oil. Propane gas can be substituted with other hydrocarbon solvent if desired. A variety of natural organic raw materials can be processed using the apparatus and method of this invention.

Many other changes and modifications can be made in the present invention without departing from the spirit thereof. I, therefore, pray that my rights to the present invention be limited only by the scope of the appended claims.

I claim:

1. An apparatus for extracting oil from oil-bearing plant material, comprising:
a source of hydrocarbon solvent;
an extraction assembly having an extraction vessel receiving the oil-bearing plant material;
a separator assembly operationally connected to the extraction assembly, the separator assembly separating the hydrocarbon solvent from oil extracted in the extraction vessel;
an upright stand supporting the extraction vessel; and
a solvent recovery assembly operationally connected to the separator assembly and the source of hydrocarbon solvent, the solvent recovery assembly comprising a gas recovery/control unit having a recycling pump and a condenser unit.

2. The apparatus of claim 1, the extraction assembly comprising a tubular hollow extraction vessel having an open top and an open bottom, a top cup detachably engageable with the open top and a bottom cup detachably engageable with the open bottom of the extraction vessel.

3. The apparatus of claim 1, wherein the top cup has longitudinal dimensions at least slightly greater than longitudinal dimensions of the bottom cup.

4. The apparatus of claim 1, wherein the top cup has longitudinal dimensions twice as great as longitudinal dimensions of the bottom cup.

5. The apparatus of claim 2, wherein a peripheral flange extends outwardly from the open top and a peripheral flange extends outwardly from the open bottom of the extraction vessel.

6. The apparatus of claim 5, wherein the top cup is provided with a peripheral flange matching in configuration the peripheral flange of the top cup, and wherein the bottom cup is provided with a peripheral flange matching in configuration the peripheral flange of the bottom cup.

7. The apparatus of claim 6, wherein a top sealing clamp is removably secured to the peripheral flanges of the top end and the top cup, and a bottom sealing clamp is removably secured to the peripheral flanges of the bottom end and the bottom cup of the extraction vessel.

8. The apparatus of claim 2, wherein a top perforated gasket is sandwiched between the top cup and the open top of the extraction vessel.

9. The apparatus of claim 2, wherein a bottom perforated gasket and a fine filter is sandwiched between the bottom end and the bottom cup of the extraction vessel.

10. The apparatus of claim 2, wherein the top cup has a top plate closing an upper end of the top cup, the top plate carrying a connector assembly, the connector assembly comprising operationally connected, an extractor connector conduit, a gas inlet valve fitted in the extractor connector conduit, and a pressure gauge connected to the gas inlet valve.

11. The apparatus of claim 10, the connector assembly is mounted in fluid communication between the source of hydrocarbon solvent and the top cup.

12. The apparatus of claim 10, wherein one end of the extractor connector conduit is provided with a quick connect male connector member.

13. The apparatus of claim 2, wherein the bottom cup has a bottom plate closing a lower end of the bottom cup, the bottom plate being provided with a liquid outlet conduit in fluid communication with interior of the extraction vessel and an extractor outlet valve operationally connected with the liquid outlet conduit.

14. The apparatus of claim 13, wherein a quick connector member is secured to a lower end of the liquid outlet conduit.

15. The apparatus of claim 13, wherein the separator assembly is mounted below the extraction assembly and in fluid communication therewith.

16. The apparatus of claim 15, the separator assembly comprising a hollow separator vessel having an open top and a closed bottom, and a separator vessel cap detachably sealingly engageable with the open top of the separator vessel.

17. The apparatus of claim 16, wherein the separator vessel cap carries a separator connector conduit mounted for sealing engagement with the liquid outlet conduit of the bottom cup.

18. The apparatus of claim 16, comprising a separator vessel sealing clamp detachably engageable with the separator vessel cap and the separator vessel, and wherein a sealing gasket is fitted between the separator vessel cap and the separator vessel.

19. The apparatus of claim 16, the separator vessel cap carrying a gas outlet conduit in fluid communication with interior of the separator vessel, a pressure gauge, and a gas outlet valve operationally connected to the solvent recovery assembly.

20. The apparatus of claim 16, the separator vessel cap carrying a thermal probe member detecting temperature conditions inside the separator vessel, the thermal probe being operationally connected to a temperature monitoring member supported by the upright stand.

21. The apparatus of claim 16, wherein the separator assembly comprises a thermal jacket secured on exterior of the separator vessel.

22. The apparatus of claim 21, wherein the thermal jacket is operationally connected to a heat source and transferring heat to the separator vessel.

23. The apparatus of claim 22, wherein the heat source is a re-circulating water heater.

24. The apparatus of claim 16, the gas recovery/control unit is mounted between the separator assembly and the source of hydrocarbon solvent.

25. The apparatus of claim 24, wherein the gas recovery/control unit has an inlet side connected to the separator vessel and an outlet side connected to the source of hydrocarbon solvent.

26. The apparatus of claim 24, wherein the recycling pump has a pump control knob and a pressure indicator, and the condenser having a condenser control knob and a monitor, the condenser being adapted to condense gas evacuated from the separator vessel.

27. The apparatus of claim 26, wherein the source of hydrocarbon solvent comprises a gas tank retaining a hydrocarbon solvent, the gas tank being operationally connected, on an outlet side, to an inlet of the extraction assembly.

28. The apparatus of claim 2, the upright stand comprises a pair of horizontal base members configured for positioning on a horizontal surface and secured in a spaced-apart parallel relationship by a first cross bar, a pair of upright supports extending upwardly from the base members, and a plurality of spaced apart parallel cross members extending between the upright members.

29. The apparatus of claim 28, wherein a Y-shaped upper yoke is secured to a cross member and extends horizontally outwardly from the cross member, said upper yoke engaging the extraction vessel.

30. The apparatus of claim 29, comprising a pair of bottom support bars secured in a spaced-apart relationship to a second cross member, the bottom support bars extending transversely to a longitudinal axis of the second cross member.

31. The apparatus of claim 30, wherein the bottom cup rests on the bottom support bars when the extraction vessel is mounted on the upright stand.

32. An apparatus for extracting oil from oil-bearing plant material, comprising:
a source of hydrocarbon solvent comprising a gas tank retaining the hydrocarbon solvent;
an extraction assembly having an extraction vessel receiving the oil-bearing plant material, the extraction assembly comprising a tubular hollow extraction vessel having an open top and an open bottom, a top cup detachably engageable with the open top and a bottom cup detachably engageable with the open bottom of the extraction vessel a separator assembly operationally connected to the extraction assembly, the separator assembly separating the hydrocarbon solvent from oil extracted in the extraction vessel, the separator assembly comprising a hollow separator vessel having an open top and a closed bottom, and a separator vessel cap detachably sealingly engageable with the open top of the separator vessel;
an upright stand supporting the extraction vessel; and
a solvent recovery assembly operationally connected to the separator assembly and the source of hydrocarbon solvent, the solvent recovery assembly comprising gas recovery/control unit having a recycling pump and a condenser unit, gas recovery/control unit mounted between the separator assembly and the gas tank.

33. The apparatus of claim 32, wherein the gas recovery/control unit has an inlet side connected to the separator vessel and an outlet side connected to the gas tank.

34. The apparatus of claim 32, the upright stand comprising a pair of horizontal base members configured for positioning on a horizontal surface and secured in a spaced-apart parallel relationship by a first cross bar, a pair of upright supports extending upwardly from the base members, and a plurality of spaced apart parallel cross members extending between the upright members.

35. The apparatus of claim 34, wherein a Y-shaped upper yoke is secured to a cross member and extends horizontally outwardly from the cross member, said upper yoke engaging the extraction vessel.

36. The apparatus of claim 35, comprising a pair of bottom support bars secured in a spaced-apart relationship to a second cross member, the bottom support bars extending transversely to a longitudinal axis of the second cross member.

37. The apparatus of claim 36, wherein the bottom cup rests on the bottom support bars when the extraction vessel is mounted on the upright stand.

38. The apparatus of claim 32, wherein a top perforated gasket is sandwiched between the top cup and the open top of the extraction vessel, and a bottom perforated gasket and a fine filter are sandwiched between the bottom end and the bottom cup of the extraction vessel.

39. The apparatus of claim 32, wherein the top cup has longitudinal dimensions at least slightly greater than longitudinal dimensions of the bottom cup.

40. The apparatus of claim 32, wherein the top cup has longitudinal dimensions twice as great as longitudinal dimensions of the bottom cup.

41. The apparatus of claim 32, wherein the top cup has a top plate closing an upper end of the top cup, the top plate carrying a connector assembly, the connector assembly comprising operationally connected, an extractor connector conduit, a gas inlet valve fitted in the extractor connector conduit, and a pressure gauge connected to the gas inlet valve, the connector assembly being mounted in fluid communication between the gas tank and the top cup.

42. The apparatus of claim 32, wherein the separator assembly comprises a thermal jacket secured on exterior of the separator vessel.

43. The apparatus of claim 42, wherein the thermal jacket is operationally connected to a heat source and transferring heat to the separator vessel.

44. The apparatus of claim 43, wherein the heat source is a re-circulating water heater.

45. The apparatus of claim 32, wherein the separator vessel cap carries a separator connector conduit mounted for sealing engagement with the liquid outlet conduit of the bottom cup.

46. The apparatus of claim 45, comprising a separator vessel sealing clamp detachably engageable with the separator vessel cap and the separator vessel, and wherein a sealing gasket is fitted between the separator vessel cap and the separator vessel.

47. The apparatus of claim 45, the separator vessel cap carrying a gas outlet conduit in fluid communication with interior of the separator vessel, a pressure gauge, and a gas outlet valve operationally connected to the solvent recovery assembly.
